(19) United States
(12) Patent Application Publication
(10) Pub. No.: US 2002/0196882 A1
(43) Pub. Date: Dec. 26, 2002

(54) Transmission method capable of synchronously transmitting information in many ways

(76) Inventors: Douglas W. Wang, Hsinchu City (TW); Yu-Chang Chang, Hsinchu City (TW); Wei-Shang Chen, Taichung City (TW); Dick Chang, Hsinchu City (TW); Yao-Lung Tsai, Taichung Hsian (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/888,552

(22) Filed: Jun. 26, 2001

(51) Int. Cl. G06F 15/16; H04L 7/00

(52) U.S. Cl. 375/355; 709/219; 375/354

(57) ABSTRACT

The present invention provides a transmission method capable of synchronously transferring information in many ways to simultaneously transfer data to plural receivers. In the transmission method of the present invention, a control menu and data to be transferred are first provided, and predetermined receivers are then selected. Next, an image capturing device is used to scan the control menu and the data to be transferred and convert them into an electric signal, which is then transferred to a computer server. The computer server discriminates the electric signal and converts it into an image signal. If the result of discrimination is successful, the image signal is transferred to an FTP server or a client computer so that the receivers can receive the image signal in predetermined ways of reception. The present invention has the characteristics of synchronous and manifold transmission, fast transmission, and convenient use.

### FIELD OF THE INVENTION

The present invention relates to a transmission method of images and data and, more particularly, to a transmission method capable of utilizing scanners, digital copiers, or faxes to synchronously transfer images, data, or information in many ways to receivers of different groups.

### BACKGROUND OF THE INVENTION

Along with continual development of the Internet, using computers to search data, download data, send electronic mails (e-mails), transfer data, or chat on the networks have become inevitable activities of users. Therefore, computers and the networks are exploited to achieve the object of fast transmission of a great deal of important information.

In the transmission of text or image files, no matter what kind of transmission way such as by faxing or by first scanning and then sending via email is used, a user must determine the transmission way himself, and then transfer the files to receivers. The receivers must receive the files in the same way. However, not all the receivers can receive the files in the same way so that the sender must use different transmission ways according to the real situations of the receivers. If there are more receivers and the ways of reception differ, one-by-one manual transmission way must be adopted, resulting in cumbersome and time-consuming operation. Moreover, it is likely that some receivers may be missed, causing much trouble to the user. Furthermore, for some outdoor people, they cannot acquire the data or image in real time even if they have personal digital assistants (PDAs). If there are many receivers, a user cannot simultaneously transfer data in many ways.

Accordingly, the present invention proposes a new transmission method of information to synchronously send information in many ways to predetermined single or plural receivers by simultaneously using different transmission ways.

### SUMMARY OF THE INVENTION

The primary object of the present invention is to provide a transmission method of information, which utilizes scanners, digital copiers, or faxes to synchronously transfer images, data, or information in many ways to receivers of different groups. The receivers can receive the information by personal computers, emails, faxes, or PDAs. Thereby, a user can synchronously and fast transfer files or documents to predetermined single or plural receivers so that the receivers can acquire the files or documents in real time.

Another object of the present invention is to provide a transmission method capable of synchronously transferring information in many ways and having the characteristics of simple operation and quick transmission. It is not necessary to manually transfer one by one, hence saving the manpower and the time of transmission.

Yet another object of the present invention is to provide a transmission method capable of synchronously transferring information in many ways to simultaneously and fast transfer files or documents to plural receivers, hence preventing the user from delaying important opportunity and time.

According to the present invention, a control menu and data to be transferred are first provided, and predetermined receivers are then selected. Next, an image capturing device is used to scan the control menu and the data to be transferred and convert them into an electric signal, which is then transferred to a computer server. The computer server discriminates the identification and content of the electric signal and converts it into an image signal. If the result of discrimination is successful, the image signal is transferred to a file transfer protocol (FTP) server or a client computer to distribute to the predetermined receivers.

The various objects and advantages of the present invention will be more readily understood from the following detailed description when read in conjunction with the appended drawings, in which:

### BRIEF DESCRIPTION OF THE DRAWINGS

FIG. 1 is a block diagram of the flowchart of the present invention; and

FIG. 2 is a block diagram of the flowchart according to another embodiment of the present invention.

### DETAILED DESCRIPTION OF THE PREFERRED EMBODIMENTS

The transmission method of the present invention can synchronously transfer electronic maps, text documents, and image facsimiles to be transferred in real time in many ways to plural receivers. Moreover, the transmission method of the present invention can simultaneously and fast transfer data to the receivers via different transmission ways according to means of reception of the receivers.

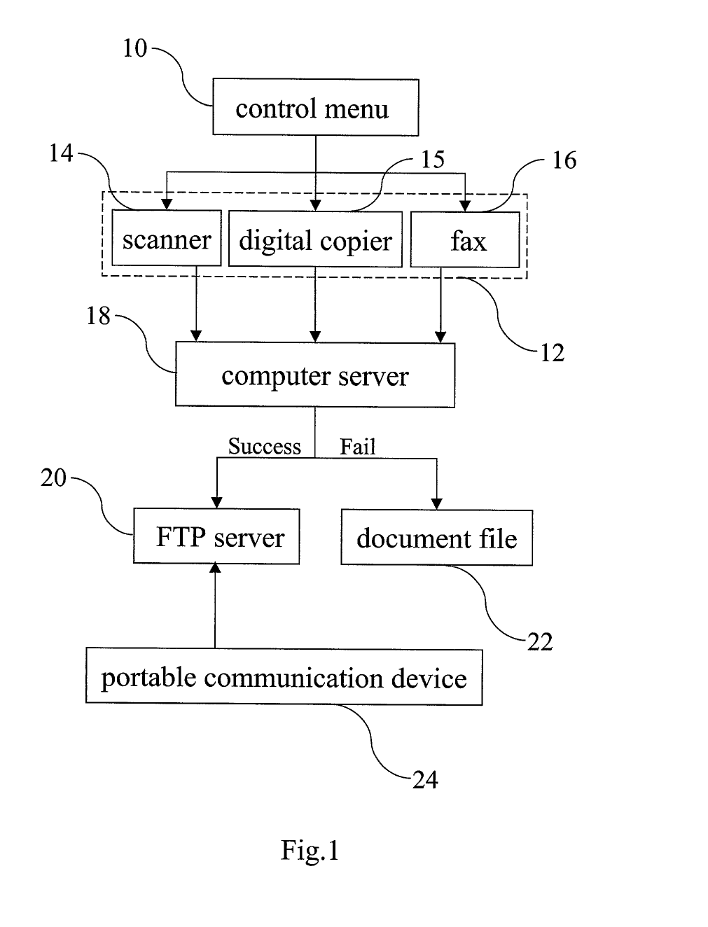

The function and effect of the present invention will be illustrated below with the manifold transmission method of portable communication devices as an example. For a portable communication device such as a PDA or a palm computer, transmission of data thereof can only be accomplished in one-to-one way. Manifold wireless transmission of data cannot be achieved. As shown in FIG. 1, in the transmission method of the present invention, a control menu 10 and data to be transferred are first provided. The control menu 10 at least comprises a list of receivers, a code area of the sender, and a blank field. A code number of the sender is first filled in the code area of the sender for discrimination of the sender. Next, the data to be transferred is filled in the blank field, or the control menu 10 is directly used as the first page of the data to be transferred, and predetermined receivers are selected among the list of receivers in the control menu 10. There is no upper limit of the number of receivers.

Subsequently, an image capturing device 12, generally being a scanner 14, a digital copier 15, or a fax 16, is used to scan the control menu 10 and the data to be transferred to convert them into an electric signal, which is then transferred to a computer server 18. After the computer server 18 receives the electric signal, the software therein starts discriminating the electric signal to discriminate the identification of the sender, the transferred data, and the identifications of the receivers, and converts the transferred data into an image signal. The data and time of discrimination can also be stored in the computer server 18 for inquiry. If the result of discrimination is successful, the image signal is transferred from the computer server 18 to an FTP server 20; otherwise the image signal is automatically transferred into a document file 22 in the computer server 18. When the FTP server 20 receives the image signal, it temporarily stores it therein so that the selected receivers can download the image signal into a personal portable communication device 24 from the FTP server 20. Through this method of manifold transmission, an outdoor receiver can receive various kinds of information in real time via the portable communication device 24. Moreover, many portable communication devices 24 can be simultaneously connected to the synchronized FTP server 20.

The above scanner 14 is connected to the computer server 18 via a small computer serial interface (SCSI) or a universal serial bus (USB) interface for transmission of signals. The fax 16 is connected to the computer server 18 via a telephone line. Additionally, an FTP target area is further provided on the control menu 10 so that the control menu 10 has the function of selecting which one department is to be transferred on the FTP target area. Through this categorization, the receivers can find the required data area more conveniently, hence facilitating the reception of data for the receivers.

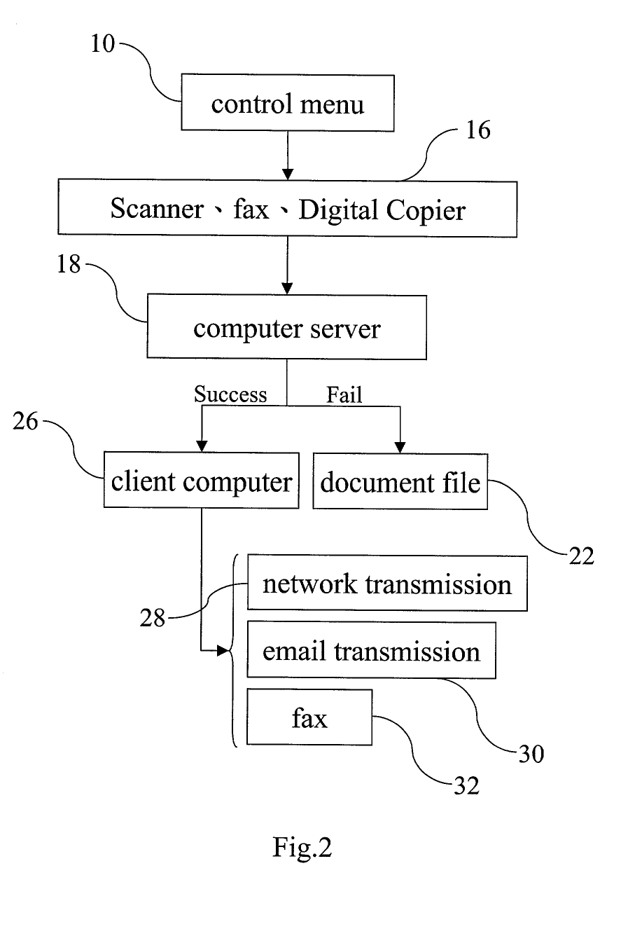

In addition to using the portable communication devices 24 as the receiving devices of the receivers, different receiving devices can be simultaneously utilized to synchronously receive the transferred data in many ways. As shown in FIG. 2, in this transmission method, a code number of the sender and predetermined plural receivers are first selected on the control menu 10. Next, the fax 16 is used to scan the control menu 10 and the data to be transferred to convert them into an electric signal, which is then transferred to the computer server 18. After the computer server 18 receives the electric signal, the software therein starts discriminating the electric signal to discriminate the identification of the sender, the transferred data, and the identifications of the receivers, and converts the transferred data into an image signal. If the result of discrimination is successful, the image signal is transferred from the computer server 18 to a client computer 26; otherwise the image signal is automatically transferred into the document file 22 in the computer server 18. When the client computer 26 receives the image signal, software therein is used to distribute according to the setting of the image signal and to select the mode of transmission, hence synchronously transferring the image signal to different receivers via network transmission 28, email 30, or facsimile output 32. The client computer can be any computer in an office.

Therefore, the synchronous transmission method of information of the present invention utilizes scanners, digital copiers, or faxes to synchronously transfer images, data, or information in many ways to receivers of different groups. The receivers can receive the information by personal computers, emails, faxes, or PDAs. Thereby, a sender (user) can synchronously and fast transfer files or documents to predetermined plural receivers so that the receivers can acquire the files or documents in real time. It is not necessary to manually transfer one by one, hence saving the manpower and the time of transmission and avoiding the situation that some receivers are missed.

Additionally, for some information to be acquired instantly, the present invention can synchronously and fast transfer files, electronic maps, documents, or images to the receivers, preventing the user from delaying important opportunity and time.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A transmission method capable of synchronously transferring information in many ways, said method simultaneously transferring data to be transferred to portable communication devices of single or plural receivers, said transmission method comprising the steps of:
providing a control menu at least comprising a name list and data to be transferred, selecting predetermined receivers;
utilizing an image capturing device to scan said control menu and said data to be transferred and convert them into an electric signal;
using a computer server to receive and discriminate said electric signal and then convert said electric signal into an image signal, sending out said image signal via said computer server if the result of discrimination is successful; and
using an FTP server to receive said image signal and temporarily store it therein so that said receivers can download said image signal from said FTP server to said portable communication devices.

2. The transmission method as claimed in claim 1, wherein said image signal is transferred into a document file in said computer server if the discrimination fails.

3. The transmission method as claimed in claim 1, wherein a sender code area is further provided on said control menu for discrimination of the sender.

4. The transmission method as claimed in claim 1, wherein an FTP target area is further provided on the control menu for reception of the receivers.

5. The transmission method as claimed in claim 1, wherein said data to be transferred comprises image and document data.

6. The transmission method as claimed in claim 1, wherein said image capturing device is a scanner, a digital copier, or a fax.

7. A transmission method capable of synchronously transferring information in many ways, said method simultaneously transferring data to be transferred to single or plural receivers, said transmission method comprising the steps of:
providing a control menu at least comprising a name list and data to be transferred, selecting predetermined receivers;
utilizing an image capturing device to scan said control menu and said data to be transferred and convert them into an electric signal;
using a computer server to receive and discriminate said electric signal and then convert said electric signal into an image signal, transferring said image signal from said computer server to at least a client computer if the result of discrimination is successful; and
using software in said client computer to distribute said image signal according to the setting thereof, select the mode of transmission, and transfer said image signal to said receivers.

8. The transmission method as claimed in claim 7, wherein said image signal is transferred into a document file in said computer server if the discrimination fails.

9. The transmission method as claimed in claim 7, wherein a sender code area is further provided on said control menu for discrimination of the sender.

10. The transmission method as claimed in claim 7, wherein said data to be transferred comprises image and document data.

11. The transmission method as claimed in claim 7, wherein said image capturing device is a scanner, a digital copier, or a fax.

12. The transmission method as claimed in claim 7, wherein the ways of reception of said receivers are selected among the groups of network transmission, email transmission, facsimile output, and portable communication devices.
